(19) United States
(12) Patent Application Publication
(10) Pub. No.: US 2009/0261146 A1
(43) Pub. Date: Oct. 22, 2009

(54) Donor material technology for friction stir welding

(76) Inventors: Gene J. Hou, Virginia Beach, VA (US); Keith M. Williamson, Norfolk, VA (US); Saptarshi Mandal, Norfolk, VA (US); Abdelmageed A. Elmustafa, Yorktown, VA (US); Ayodeji Demuren, Virginia Beach, VA (US); Sebastian Y. Bawab, Chesapeake, VA (US); Justin M. Rice, Virginia Beach, VA (US)

Correspondence Address: WILLIAMS MULLEN, 222 CENTRAL PARK AVENUE, SUITE 1700, VIRGINIA BEACH, VA, 23462, US

(21) Appl. No.: 12/383,661

(22) Filed: Mar. 25, 2009

Related U.S. Application Data
(60) Provisional application No. 61/070,642, filed on Mar. 25, 2008.

(51) Int. Cl. B23K 20/12

(52) U.S. Cl. 228/112.1; 228/2.1

(57) ABSTRACT

A method and apparatus is disclosed for forming a friction stir weld joint using a friction stir tool. A first metallic work material and a second metallic work material are provided and are substantially abutted to define a joint interface having a weld surface. A quantity of metallic donor material is provided and deposited into a depression formed in the weld surface along the joint interface. A friction stir welding tool having a shoulder and a pin depending from the shoulder is provided and applied against the donor material within the depression using a plunge force. The friction stir welding tool is rotated such that the pin contacts the donor material and heats the donor material to plasticize at least a portion of the donor material forming a friction stir weld joint. The friction stir welding tool is then urged along the joint interface.

### CROSS-REFERENCE TO RELATED APPLICATION

The present application claims priority benefit of U.S. Provisional Application No. 61/070,642, filed Mar. 25, 2008, which is herein incorporated by reference in its entirety.

### STATEMENT OF RIGHTS TO INVENTIONS MADE UNDER FEDERALLY SPONSORED RESEARCH AND DEVELOPMENT

The U.S. Government has a paid-up license in this invention and the right in limited circumstances to require the patent owner to license others on reasonable terms as provided for by the terms of Grant No. 0343646 awarded by the National Science Foundation.

### BACKGROUND OF THE INVENTION

Friction stir welding (FSW) is a solid-state welding process which allows work materials to be joined together. The FSW process involves a cylindrical, shouldered tool with a profiled pin which is rotated and plunged into a joint line between two pieces of material, which are abutted together. FSW generates heat by friction between the tool and the surrounding material, which thereby causes material softening and allows the tool to move along the joint line between two materials.

This process has many advantages over conventional fusion-welding processes, including low environmental impact, good mechanical properties in the welded condition, improved safety due to the absence of toxic fumes or the spatter of molten material and the ability to operate in all positions.

However, some disadvantages and limitations have been recognized in using FSW. Although the process has been successfully used in some industries, it has not been popular in heavy industries, such as the shipbuilding industry. The difficulty arises in the high wear on the tool in heavy industries, where excessive loads can severely shorten the life of the tool. Because of this, some in the field have concluded that FSW is unsuited for use with hard metals, such as steel.

Therefore, there is a long felt need to broaden application of FSW so that it may be more economically and feasibly used in heavy industries. There is also a need for an application that extends the tool life in the FSW process.

### SUMMARY OF THE INVENTION

In one aspect of the present invention, a method for forming a friction stir weld joint using a friction stir tool includes providing a first metallic work material and a second metallic work material. The method also includes substantially abutting the first and second work materials to define a joint interface having a weld surface. A quantity of metallic donor material is provided and a depression having a shape is formed in the weld surface along the joint interface. The donor material is formed into a shape corresponding with the shape of the depression. The donor material is deposited into the depression. The melting point of the donor material may be less than the melting point of either the first or second work materials. A friction stir welding tool is provided having a shoulder and a pin depending from the shoulder. The tool is applied against the donor material within the depression using a plunge force and is rotated so that the shoulder and the pin contact the donor material and heats the donor material to plasticize at least a portion of the donor material forming a friction stir weld joint. The tool is then urged along the joint interface.

The present invention may further comprise forming a pinhole and urging the friction stir welding tool through the pinhole and then along the joint interface. The pinhole may be formed in the depression using the pin prior to entry of the pin into the workpiece or formed using the pin.

In another aspect of the present invention, the first and second work materials comprise steel, and the donor material is chosen from the group consisting of aluminum alloys and copper.

The shoulder of the friction stir welding tool has an effective shoulder diameter and the depression has an effective depression diameter. In one embodiment, the effective shoulder diameter is less than the effective depression diameter.

In another aspect of the present invention, a method of friction stir welding includes providing a first metallic work material and a second metallic work material to form a workpiece. The method also includes substantially abutting the first and second work materials to define a joint interface having a weld surface. A depression is formed along the joint interface of the workpiece. A donor material is selected and disposed into the depression. A friction stir welding tool is revolved in a rotational direction and urged against the donor material to preheat at least a portion of the donor material to form a work zone along the joint interface. The tool is then urged through a pinhole of the workpiece and along the joint interface.

In yet another aspect of the present invention, the workpiece comprises steel and the donor material is chosen from the group consisting of aluminum, aluminum alloys, copper and copper alloys. In another embodiment, the donor material may comprise powder form. The shape of the depression may be substantially pyramidal, substantially conical or substantially cuboidal

In one embodiment of the present invention, the first and second work materials, without the donor material, correspond to a first required plunge force and first required shear stress for the workpiece. The donor material has a melting point and material form, such that when the donor material is disposed into the depression, the first and second work materials with the donor material correspond to a second required plunge force and second required shear stress for the workpiece. In this embodiment, the second required plunge force is substantially less than the first required plunge force. Additionally, the second required shear stress is substantially less than the first required shear stress.

In another aspect of the present invention, a friction stir welding apparatus includes a first metallic work material and a second metallic work material forming a workpiece having a pinhole. A joint interface having a weld surface is defined when the first and second work materials are abutted. The apparatus includes a depression embedded in the weld surface. A donor material is disposed within the depression. The donor material has a lower melting point than the first and second work materials. The friction stir welding tool includes a rotatable shoulder and pin structured to frictionally engage the donor material so as to plasticize at least a portion of the donor material to form a friction stir weld joint. The tool is adapted to be urged through a pinhole of the workpiece and along the joint interface.

These and other advantages of the invention will be further understood and appreciated by those skilled in the art by reference to the following written specification, claims and appended drawings.

### BRIEF DESCRIPTION OF DRAWINGS

FIG. 1 is a perspective view illustrating a workpiece made in accordance with an embodiment of the present invention;

FIG. 2 is an exploded perspective view of FIG. 1, illustrating an embodiment of the present invention;

FIG. 3 is an enlarged fragmentary cross-sectional view illustrating a workpiece made in accordance with an embodiment of the present invention;

FIG. 4 is perspective view illustrating a workpiece made in accordance with an embodiment of the present invention;

FIG. 5a is an enlarged fragmentary cross-sectional view illustrating the FSW process in accordance with an embodiment of the present invention;

FIG. 5b is an enlarged fragmentary cross-sectional view illustrating the FSW process in accordance with an embodiment of the present invention;

FIG. 5c is an enlarged fragmentary cross-sectional view illustrating the FSW process in accordance with an embodiment of the present invention;

FIG. 6a is an enlarged partial side view illustrating a pin in a donor material made in accordance with an embodiment of the present invention;

FIG. 6b is an enlarged perspective view showing the work zone created during the FSW process;

FIG. 7a is a three-dimensional simulation showing temperature contours of the FSW process during the plunge phase of an embodiment of the present invention using a donor material aluminum 1100 at time step 14901;

FIG. 7b is a three-dimensional simulation showing temperature contours of the FSW process during the plunge phase of an embodiment of the present invention using a donor material aluminum 1100 at time step 16727;

FIG. 8 is a graph showing a comparison of shear stress of the FSW process with and without donor material in the workpiece in accordance with an embodiment of the present invention;

FIG. 9 is a graph showing a comparison of the axial load of the FSW process with and without donor material in the workpiece in accordance with an embodiment of the present invention; and

FIG. 10 is a flow diagram showing an embodiment in accordance with the present invention.

### DETAILED DESCRIPTION OF THE PREFERRED EMBODIMENT(S)

It is to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

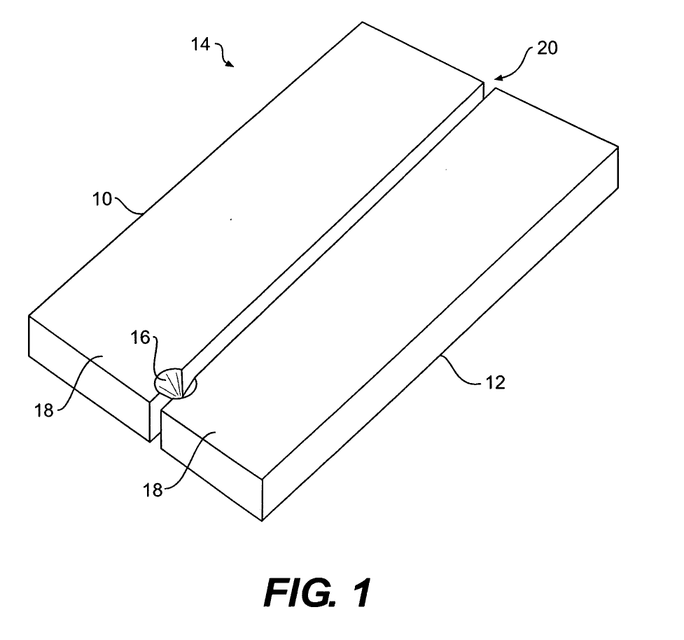

As illustrated in FIG. 1, a first metallic work material 10 and a second metallic work material 12 are chosen to be welded together to form a workpiece 14. The first and second metallic work materials 10 and 12 may comprise the same or different materials. The first and second metallic work materials 10 and 12 may comprise any metal, including hard metals, such as steel. The steel may comprise any high strength steel, including but not limited to, high strength low-alloy steel such as HSLA 65. The method of FSW of the present invention may be utilized for all friction stir welding suitable joint geometries, including butt welds, dissimilar thickness butt welds, lap penetration, and lap fillet configurations. The method of FSW may also be used in any other FSW application, including in heavy industries, such as shipbuilding, aircraft construction, automobile construction, or house construction components.

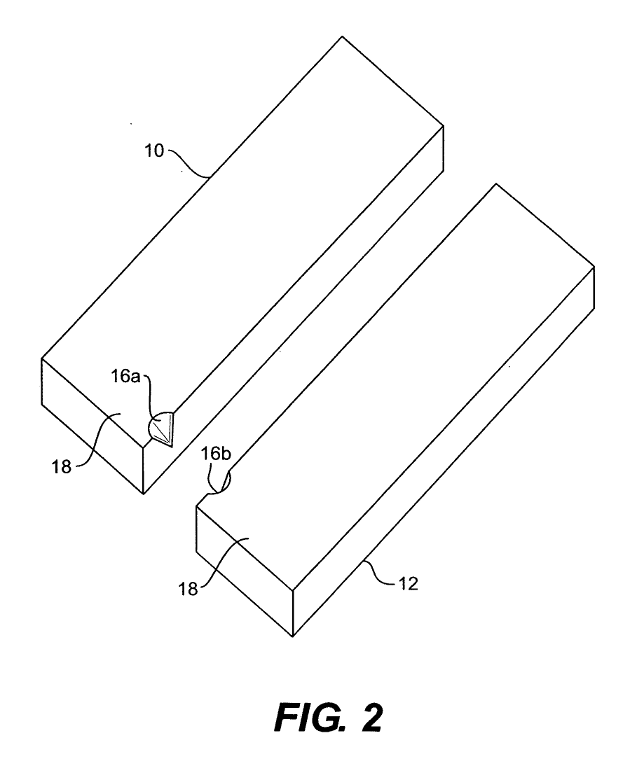

As shown in FIG. 1, the workpiece 14 comprises a depression 16 at a weld surface 18 at a desired point along the joint interface 20, which could be at the beginning of the intended weld line. In one embodiment, as shown in FIG. 2, depressions 16a and 16b may be preformed before the first and second work materials 10 and 12 are abutted or substantially abutted. In another embodiment, the depression 16 may be formed after the first and second work materials 10 and 12 are abutted. The depression may be created using any type of mechanism known in the art depending on the metallic material of the workpiece 14, including a drill.

The depression 16 may be of any shape that is suitable for use in the present invention, including but not limited to, conical or substantially conical, cuboidal or substantially cuboidal, tear-shaped or substantially tear-shaped, or oval or substantially oval, cubed or substantially cubed, triangular or substantially triangular, cylindrical or substantially cylindrical, pyramidal or substantially pyramidal, etc.

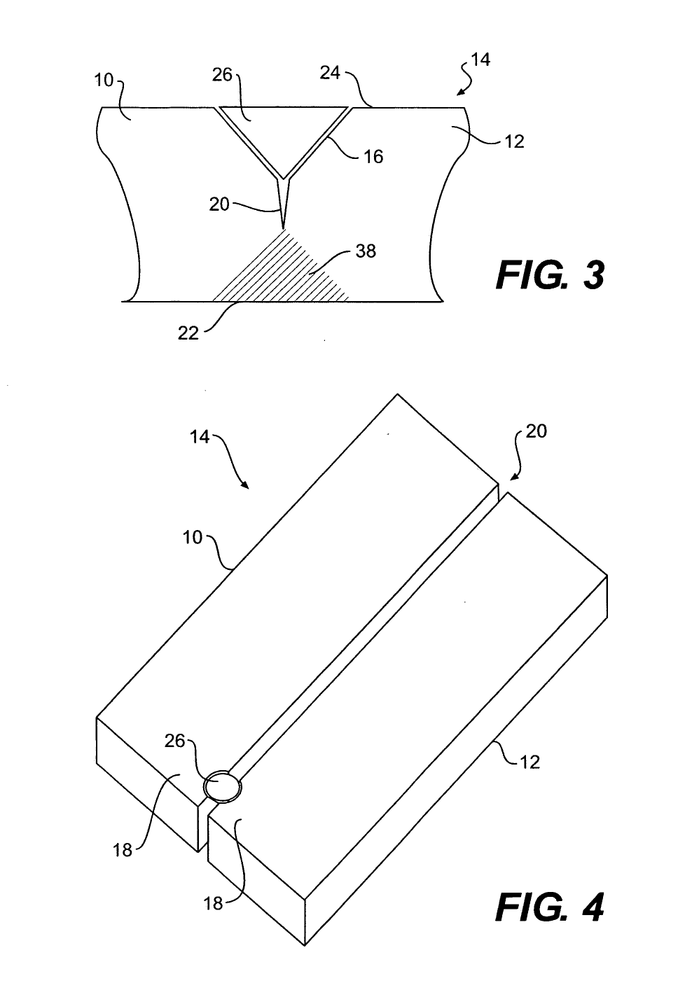

The depression 16 may be prepared at the beginning of the intended weld line. In one embodiment, the depression 16 extends along only a portion of the interface, with the remaining interface comprising only the first and second metallic work materials 10 and 12, as shown in FIG. 1. In another embodiment, there may comprise multiple depressions 16 along the joint interface 20. In yet another embodiment (not shown), the workpiece 14 may contain depressions 16 located on different sides of the workpiece 14, such as being located on opposite sides of the workpiece 14 along the joint interface 20. FIG. 3 shows this alternative embodiment, in which the workpiece 14 was first welded on a first side 22 creating a friction stir weld joint 38 of the claimed invention, as shown by the shaded portion, with a second side 24 adapted to be welded using the same FSW method by creating a depression 16 on the opposite side of the workpiece 14 and inserting the donor material 26 into the depression 16.

A metallic donor material 26 is selected based on the composition of the first metallic work material 10 and second metallic work material 12. The donor material 26 serves to reduce the amount of heat generated by surface-to-surface friction on a friction stir welding tool 28. In one embodiment, the melting point of the donor material 26 should be lower than the melting point of the first and second work materials 10 and 12.

The donor material 26 may be plasticized with less work from the tool 28 than the first and second work materials 10 and 12. For example, in some embodiments the donor material 26 may comprise a material that is different than the first or second work materials 10 and 12, and if the donor material 26 has a lower melting point than the first or second work materials 10 and 12, then the donor material 26 may require less work and a lower plunge force. The donor material 26 may also comprise the same or different material as the first or second work materials 10 and 12 if the donor material 26 is in a different material form that would be easier to plasticize than the material form of first and second work materials. For example, this may be achieved by using a donor material 26 comprising a powder form, since the powder form may be easier to plasticize than the first and second work materials 10 and 12 in solid form.

The donor material 26 may also be appropriate if it comprises a less hard material than the first and second work materials 10 and 12. However, the donor material 26 may be a harder material than the first and second work materials 10 and 12, so long as the harder donor material 26 is in a different material form that reduces the required work and plunge force, such as powder form. The donor material 26 may also be appropriate if it comprises lower flow stress than the first and second work materials 10 and 12. In one embodiment, the donor material 26 may include various types of metals and metal alloys, such as aluminum, aluminum alloys, copper, and copper alloys.

If the donor material 26 is in a different material form than the workpiece 14, such as a powder, then the donor material 26 may be deposited into the depression 16 by simply pouring the donor material 26 into the depression 16 or insertion by any other method known in the art. If the donor material 26 comprises a metal in solid form, then the donor material 26 may be shaped to correspond to the shape of the depression 16. For example, if the depression 16 is conical, then the donor material may also be similarly shaped prior to insertion into the depression 16. One advantage of shaping the depression 16 and the donor material 26 into corresponding cubed, triangular, cuboidal, pyramidal or other shapes having angular sides is to minimize rotation of the donor material 36 during the FSW process.

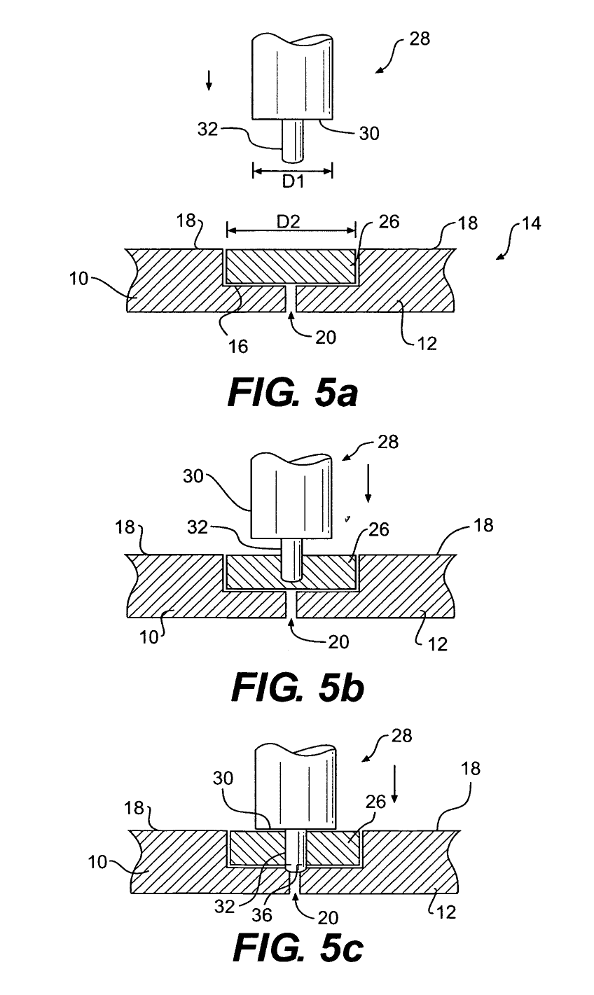

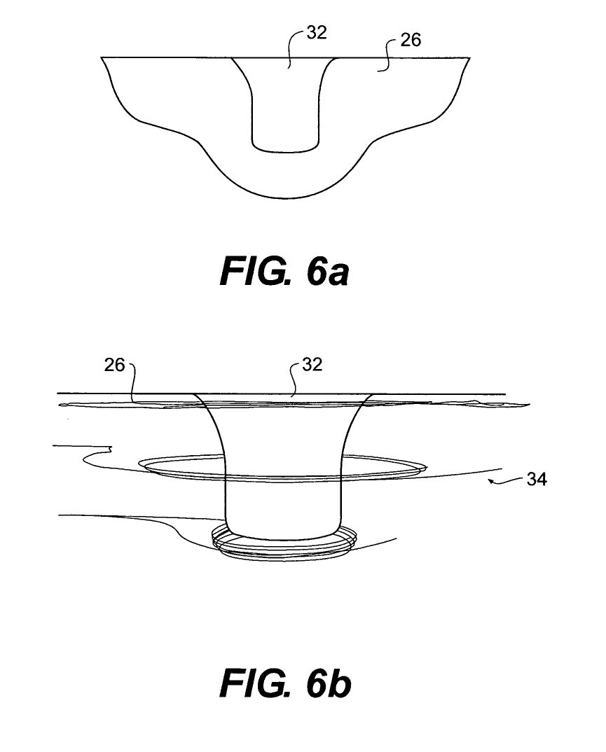

The donor material 26 is deposited or inserted into the depression 16 as shown in FIG. 4. To start the FSW process, the friction stir welding tool 28 comprising a tool having a shoulder 30 and a pin 32 is revolved in a rotational direction. As shown in FIGS. 5a and 5b, the pin 32 is then urged against and plunged into the depression 16 at a desired plunge force, to plasticize at least a portion of the donor material 26 to form a friction stir weld joint along the joint interface 20. The plunging process generates a work zone 34 with a flow surrounding the tool 28, as shown in FIGS. 6a and 6b.

In one embodiment, as shown in FIG. 5a, the shoulder 30 of the tool 28 has an effective shoulder diameter D1, and the depression 16 has an effective depression diameter D2. In this embodiment, the effective diameter D1 of the shoulder 30 should be less than the effective diameter D2 of the depression 16. The shoulder 30 has a smaller effective diameter D1 than the effective diameter D2 of the depression 16 to ensure that the tool 28 is entirely embedded within the donor material 26 during the initial stages of the FSW process. For purposes of this application, the term “effective shoulder diameter” shall be the longest dimension of the shape of the shoulder 30, as measured from the perspective of the plane of the weld surface 18. For purposes of this application, the term “effective depression diameter” shall be the shortest dimension of the shape of the depression 16, as measured from the perspective of the plane of the weld surface 18.

It is believed that plunging of the tool 28 into the workpiece 14 is one of the most detrimental phases of the conventional FSW process to the tool 28. The present invention mitigates the damage caused during the plunging phase by using the work zone 34 as a pre-heating mechanism to soften nearby work materials 10 and 12 that are ahead of the tool 28. The heat generated in the donor material 26 is transferred into the work materials 10 and 12 by thermal conduction. In one embodiment, the flow can shield the direct friction contact between the surface of the tool 28 and the harder work materials 10 and 12.

The combination of preheating and flow therefore reduces the amount of the energy and the friction force required for the advancement of the tool 28, which thereby reduces the shear stress as well as the wearing on the surface of the tool 28. For example, the first and second work materials 10 and 12 without the donor material 26 correspond to a first required shear stress for the workpiece 14. Moreover, the donor material 26 has a melting point and material form, such that when the donor material 26 is disposed into the depression 16, the first and second work materials 10 and 12 with the donor material 26 correspond to a second required shear stress for the workpiece 14. In this embodiment, the second required shear stress is substantially less than the first required shear stress over the plunge phase.

Additionally, the present invention reduces the required plunge force needed to effectively friction stir weld a workpiece 14. A required plunge force is the force exerted on the workpiece through and by the pin 32 and shoulder 30, along a plunge axis, over a plunge phase, in order to establish the preheated or plasticized conditions for FSW, given a particular metallic material and the desired weld characteristics. Thus, for a given material and desired weld, workpiece 14 without the donor material 26 corresponds to a first required plunge force. For the same material and desired weld characteristics, workpiece 14 with the donor material 26 corresponds to a second required plunge force. In one embodiment of the present invention, the first and second work materials 10 and 12 without the donor material 26 correspond to a first required plunge force for the workpiece 14. Moreover, the donor material 26 has a melting point and material form, such that when the donor material 26 is disposed into the depression 16, the first and second work materials 10 and 12 with the donor material 26 correspond to a second required plunge force for the workpiece 14. In this embodiment, the second required plunge force is substantially less than the first required plunge force over the plunge phase.

Once the work zone 34 is established with the flow surrounding the tool 28, the tool 28 can then be urged through a pinhole 36 into the workpiece 14. The pinhole 36 is defined as either the entry point of the pin 32 of the tool 28 from the donor material 26 into the workpiece 14, or a predrilled hole drilled into the workpiece 14 prior to the FSW process. The pinhole 36 typically corresponds to the location of the lowermost portion of the depression 16. As previously discussed, the depression 16 may comprise multiple shapes. Accordingly, the location of the pinhole 36 may vary depending on the desired shape of the depression 16. In one embodiment, the pinhole 36 may comprise a lowermost point of a conical-shaped depression 16, as shown in FIG. 2. In another embodiment, the pinhole 36 may be located at a lowermost edge of a depression having a flat cross-sectional shape, as shown in FIG. 5c. In an alternative embodiment, the pinhole 36 of the present invention may be preformed, or pre-drilled, prior to entry of the pin 32 of the tool 28 into the workpiece 14.

The tool 28 is urged through the pinhole 36 after the work zone 34 is created in the donor material 26. The tool 28 is also urged along remaining joint interface 20 of the workpiece 14 to extend the friction stir weld joint 38.

### EXAMPLES

### Example 1

Aluminum 1100 was used as the donor material inserted into the depression of a steel 1045 workpiece. A tool with 25.40 mm diameter shoulder and 6.35 mm diameter by 3.18 mm long tool pin was spun at 1,000 RPM and plunged into the donor material at a rate of 0.38 mm/s. Results were obtained by using the Computational Fluid Dynamics code software with non-Newtonian flow and low Reynolds number approximation. The flow around the tool pin during FSW is shown in FIGS. 6a and 6b.

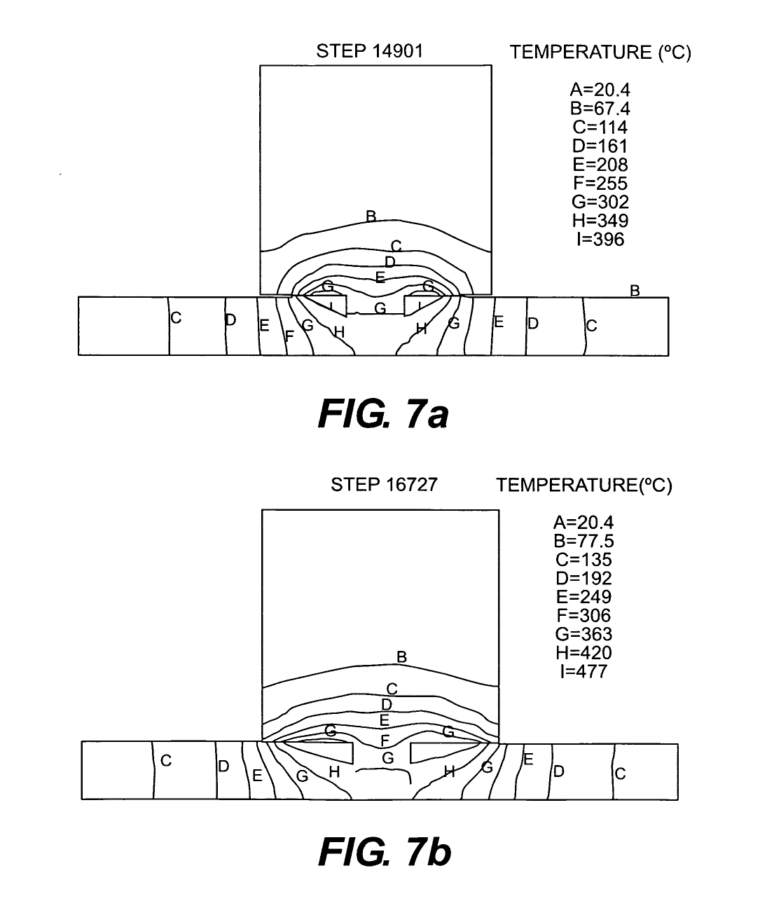

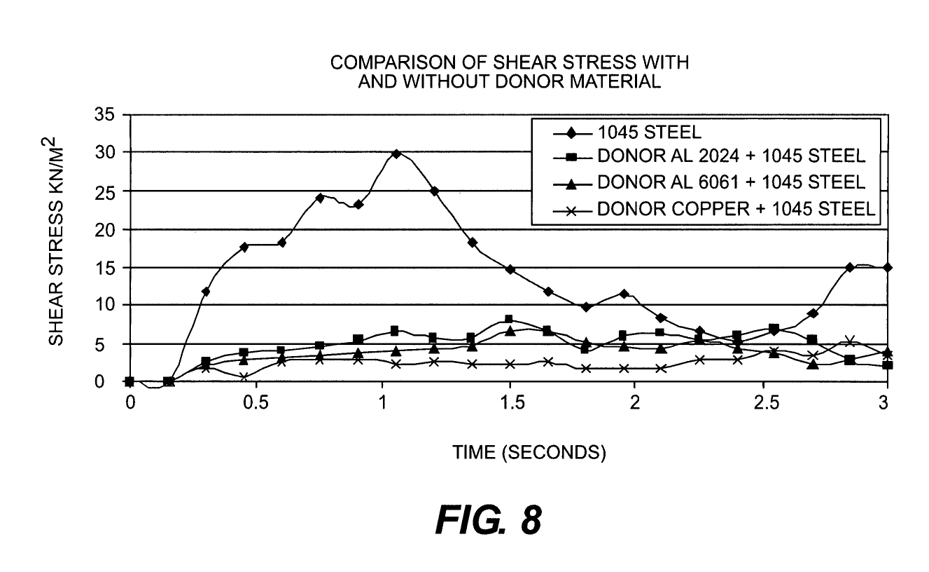

Process simulation software was also used to simulate and analyze the three-dimensional flow of the FSW metal forming process. As shown in FIGS. 7 and 8, the temperature increased continuously during the plunge process until a maximum value greater than 477° C. was attained in the workpiece just below the shoulder. Most of the heat was generated by the work required for the deformation to punch the hole. As shown in FIGS. 7a and 7b, at time step 14,901, the tool pin was 89% of the way into the donor material, and at time step 16,267, the shoulder touched the workpiece.

### Example 2

In the control test, a steel 1045 workpiece was friction stir welded without the use of a donor material. In the second test, a steel 1045 workpiece was friction stir welded with a donor material comprising Aluminum 2024. In the third test, a steel 1045 workpiece was friction stir welded with a donor material comprising Aluminum 6061. In the fourth test, a steel 1045 workpiece was friction stir welded with a donor material comprising copper.

The rotating tool was plunged into the 100 mm×100 mm×20 mm workpieces. The tool rotation speed was set at 300 RPM and the penetration speed was set at 4 mm/s. The simulation used commercial code and considered the plunge phase of the welding process. FIG. 8 shows a comparison of the interfacial shear stresses between the tool and the workpiece with and without the use of the donor materials during the plunge period. The interfacial shear stresses were much lower when using a combination of a donor material and steel as compared to a control test plunge into steel 1045 without a donor material.

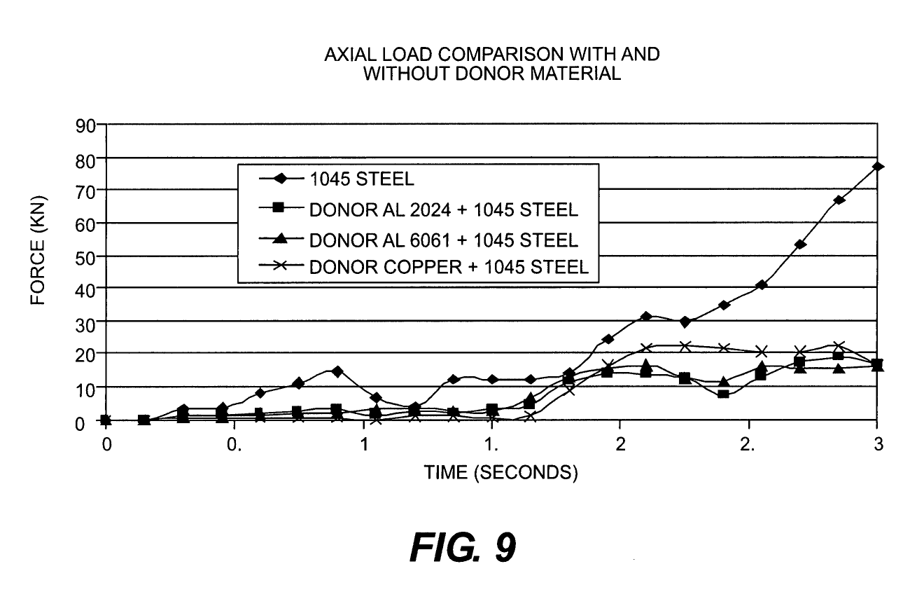

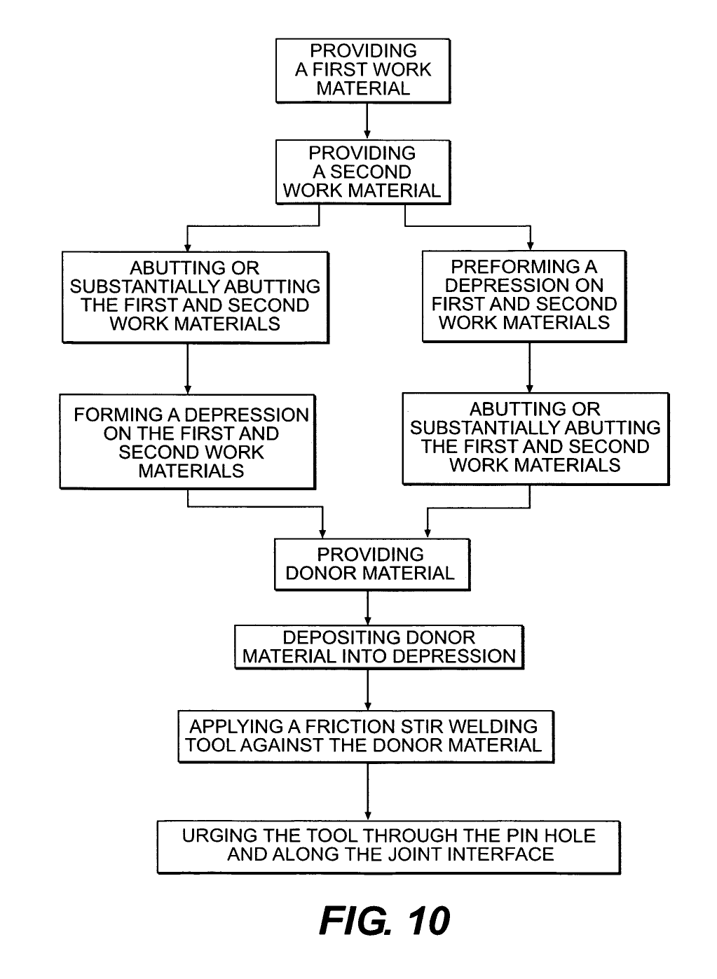

FIG. 9 shows the comparison of axial force experienced by the tool in the simulation. The control plunge into 1045 steel with a donor material produced a much higher plunge force as compared to the combination of donor materials and steel.

In the foregoing description, it will be readily appreciated by those skilled in the art that modifications may be made to the invention without departing from the concepts disclosed herein. Such modifications are to be considered as included in the following claims, unless the claims by their language expressly state otherwise.

What is claimed is:

1. A method for forming a friction stir weld joint using a friction stir tool, the method comprising:
providing a first metallic work material and a second metallic work material;
substantially abutting the first and second work materials to define a joint interface having a weld surface;
providing a quantity of metallic donor material;
forming a depression in the weld surface along the joint interface; the depression having a shape;
forming the donor material into a shape corresponding with the shape of the depression;
depositing the donor material into the depression;
providing a friction stir welding tool having a shoulder and a pin depending from the shoulder;
applying the tool against the donor material within the depression using a plunge force;
rotating the tool so that the shoulder and the pin contact the donor material and heat the donor material to plasticize at least a portion of the donor material forming a friction stir weld joint; and
urging the friction stir tool along the joint interface.

2. The method according to claim 1, further comprising the step of forming a pinhole and urging the friction stir welding tool through the pinhole and then along the joint interface.

3. The method according to claim 2, wherein the pinhole is formed prior to applying the tool against the donor material.

4. The method according to claim 2, wherein the forming the pinhole comprises forming the pinhole in the depression using the pin.

5. The method according to claim 1, wherein the melting point of the donor material is less than the melting point of either the first or second work materials.

6. The method according to claim 5, wherein the first and second work materials comprise steel, and the donor material is chosen from the group consisting of aluminum alloys and copper.

7. The method according to claim 1, wherein the shape of the depression is substantially pyramidal, substantially conical or substantially cuboidal.

8. The method according to claim 1, the shoulder having an effective shoulder diameter and the depression having an effective depression diameter, wherein the effective shoulder diameter is less than the effective depression diameter.

9. A method of friction stir welding, the method comprising:
providing a first metallic work material and a second metallic work material to form a workpiece;
substantially abutting the first and second work materials to define a joint interface having a weld surface;
forming a depression along the joint interface of the workpiece;
selecting a donor material;
disposing the donor material into the depression;
revolving a friction stir welding tool in a rotational direction and urging the friction stir welding tool against the donor material to preheat at least a portion of the donor material to form a work zone along the joint interface; and
urging the tool through a pinhole of the workpiece and along the joint interface.

10. The method according to claim 9, wherein the workpiece comprises steel.

11. The method according to claim 9, wherein the donor material is chosen from the group consisting of aluminum, aluminum alloys, copper, and copper alloys.

12. The method according to claim 9, wherein the donor material comprises the same material as either the first or second work materials, and wherein the donor material comprises powder form.

13. The method according to claim 9, wherein the shape of the depression is substantially pyramidal, substantially conical or substantially cuboidal.

14. The method according to claim 9, wherein the melting point of the donor material is less than the melting point of either the first or second work materials.

15. The method according to claim 9, further comprising:
wherein the first and second work materials without the donor material correspond to a first required plunge force for the workpiece;
wherein the donor material has a melting point and material form, such that when the donor material is disposed into the depression, the first and second work materials with the donor material correspond to a second required plunge force for the workpiece; and
wherein the second required plunge force is substantially less than the first required plunge force.

16. The method according to claim 9, further comprising:
wherein the first and second work materials without the donor material correspond to a first required shear stress for the workpiece;
wherein the donor material has a melting point and material form, such that when the donor material is disposed into the depression, the first and second work materials with the donor material correspond to a second required shear stress for the workpiece; and
wherein the second required shear stress is substantially less than the first required shear stress.

17. A friction stir welding apparatus comprising:
a first metallic work material and a second metallic work material forming a workpiece having a pinhole, wherein a joint interface is defined when the first and second work materials are abutted, the joint interface having a weld surface;
a depression embedded in the weld surface;
a donor material disposed within the depression, the donor material having a lower melting point than the first and second work materials; and
a friction stir welding tool comprising a rotatable shoulder and pin structured to frictionally engaged the donor material so as to plasticize at least a portion of the donor material forming a friction stir weld joint; and
wherein the tool is adapted to be urged through a pinhole of the workpiece along the joint interface.

18. The friction stir welding apparatus as defined in claim 17, wherein the donor material comprises a metal alloy.

19. The friction stir welding apparatus as defined in claim 17, the shoulder having an effective shoulder diameter and the depression having an effective depression diameter, wherein the effective shoulder diameter is less than the effective depression diameter.

20. The friction stir welding apparatus as defined in claim 19, wherein the workpiece comprises steel.
